(19) United States
(12) Patent Application Publication
(10) Pub. No.: US 2009/0305000 A1
(43) Pub. Date: Dec. 10, 2009

(54) INTEGRATED SEAL FOR TWO-SHOT ASSEMBLY AND METHOD OF MANUFACTURE

(75) Inventor: Michael P. Schoemann, Waterford, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/132,735

(22) Filed: Jun. 4, 2008

(51) Int. Cl. B29C 45/16; B32B 3/30

(52) U.S. Cl. 428/174; 264/255

(57) ABSTRACT

In at least one embodiment, the present invention relates to a method for making an automobile interior trim panel, where the method comprises providing a mold tool system comprising a first mold half, a second mold half and a third mold half, introducing a first resin into a first mold cavity to form a trim panel substrate, positioning the first mold half with the trim panel substrate and the third mold half proximate each other to form a second mold cavity generally contouring to the shape of the trim panel and having a first minor cavity extending generally transverse to the exterior surface of the second mold cavity, and introducing a second resin into the second mold cavity to form a cover skin extending over the substrate and having an outer surface and a tab portion extending generally away from the outer surface.

### BACKGROUND OF THE INVENTION

1. Field of the Invention

The present invention relates to an integrated seal for a two-shot assembly and method of manufacturing the same.

2. Background Art

It is known to provide an interior trim panel for a vehicle, and components thereof, which is aesthetically and/or tactilely pleasing to the vehicle occupants. Such trim panels may have a bezel disposed therein to allow for the placement of various door latch and switch assemblies within the trim panel.

Known bezels are typically formed separately from the trim panel and assembled to the trim panel during an assembly operation subsequent to forming the trim panel. A separately formed seal is typically provided between the bezel and the panel. This helps to keep dust and other debris from the electrical component and to prevent rattling of the switch. The addition of such a seal can add expense, complexity and time to the manufacturing of such parts. It would therefore be desirable to provide an improved method of manufacturing an interior trim panel that employs the use of a bezel.

### SUMMARY OF THE INVENTION

According to one aspect of the invention, the present invention relates to a method of making an automobile interior trim panel. In at least one embodiment, a method for making an automobile interior trim panel comprises:
a) providing a mold tool system comprising a first mold half, a second mold half and a third mold half;
b) positioning the first mold half and the second mold half proximate each other to form a first mold cavity;
c) introducing a first resin into the first mold cavity to form a trim panel substrate;
d) positioning the first mold half with the trim panel substrate and the third mold half proximate each other to form a second mold cavity, with the second mold cavity generally contouring to the shape of the trim panel and having a first minor cavity extending generally transverse to the exterior surface of the second mold cavity; and
e) introducing a second resin into the second mold cavity to form a cover skin extending over the substrate, with the cover skin having an outer surface and a tab portion extending generally away from the outer surface.

In at least another embodiment, the method comprises:
a) providing a mold tool system comprising a first mold half, a second mold half and a third mold half,
b) positioning the first mold half and the second mold half proximate each other to form a first mold cavity;
c) introducing a first resin into the first mold cavity to form a trim panel substrate having an opening therein;
d) positioning the first mold half with the trim panel substrate and the third mold half proximate each other to form a second mold cavity, with the second mold half having a cavity surface generally contoured to the shape of the trim panel and a first minor cavity extending generally transverse to the cavity surface of the second mold cavity; and
e) introducing a second resin into the second mold cavity to form a cover skin extending over at least a substantial portion of the substrate, with the cover skin having an outer surface and a tab portion extending generally away from the outer surface, with the tab portion circumscribing the opening and being spaced 0.25 to 5 cm from the opening.

According to another aspect of the invention, the present invention relates to a trim panel. In at least one embodiment, the trim panel comprises a trim panel substrate having an opening therein, and a cover skin extending over at least a portion of the substrate. In at least this embodiment, the cover skin has an outer surface and a tab portion extending generally away from the outer surface, and the trim panel further comprises a plurality of switches disposed within the openings, and a switch bezel disposed between the switches and the substrate, with the switch bezel cooperating with the tub portion to provide a seal.

### BRIEF DESCRIPTION OF THE DRAWINGS

FIG. 1 illustrates a perspective view of an exemplary embodiment of a trim panel assembly for a motor vehicle in accordance with the present invention;

FIG. 2 illustrates a cross-sectional view along line 2-2 of FIG. 1;

FIG. 3 is a sectional view of another exemplary embodiment of a trim panel assembly;

FIG. 4 is an exploded perspective view of portions of the trim panel assembly illustrated in FIG. 1;

FIG. 5 is a cross-sectional view of a molding tool illustrating a first cavity;

FIG. 6 is a view similar to FIG. 5 illustrating a part made by the tool;

FIG. 7 is a molding tool illustrating a second cavity; and

FIG. 8 is a molding tool illustrating a component made by the molding tool.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable preferred for a given purpose in connection with the invention implies that mixtures of any two or more members of the group or class may be equally suitable or preferred

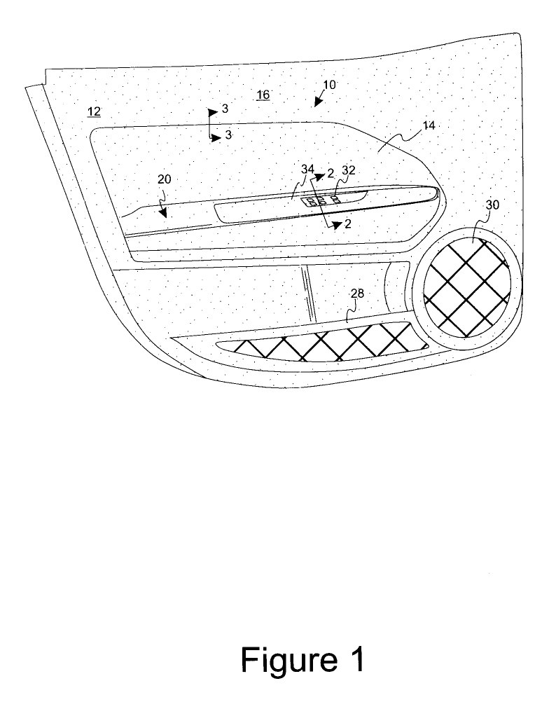

Referring to FIG. 1, there is illustrated an interior door panel 10 in accordance with at least an embodiment of the present invention. Certain aspects of the present invention will be described below in connection with the door panel 10. However, it should be understood that other trim products, such as instrument panels, glove box door covers, console sides, console covers, pillow trim panels, shelves, trim covers, A/C vents and the like may also enjoy the benefits of the present invention.

The door panel 10 illustrated in the figures includes a major panel 12 and a bolster 14 secured to the major panel portion 12. The bolster 14 can be secured to the major panel portion 12 in any suitable manner, such as by heat staking, fasteners, and adhesive. In at least certain embodiments, the major panel portion 12 is made of a relatively hard plastic.

In at least one embodiment, the bolster 14 is made of less rigid material than the major panel portion 12. In at least the illustrated embodiment, the bolster 14 makes up a substantial portion of the upper portion of the door panel 12. This is to provide a soft feel and/or a contrasting color to the upper portion of the door panel 10 relative to the remainder of the major panel portion 12. The major panel portion 12 may also include additional structures attached thereto, such as attachment features. The door panel 10 also includes an armrest 20 forming part of the bolster 14. The door panel 10 can also include additional components, such as a map pocket 28 and speaker 30.

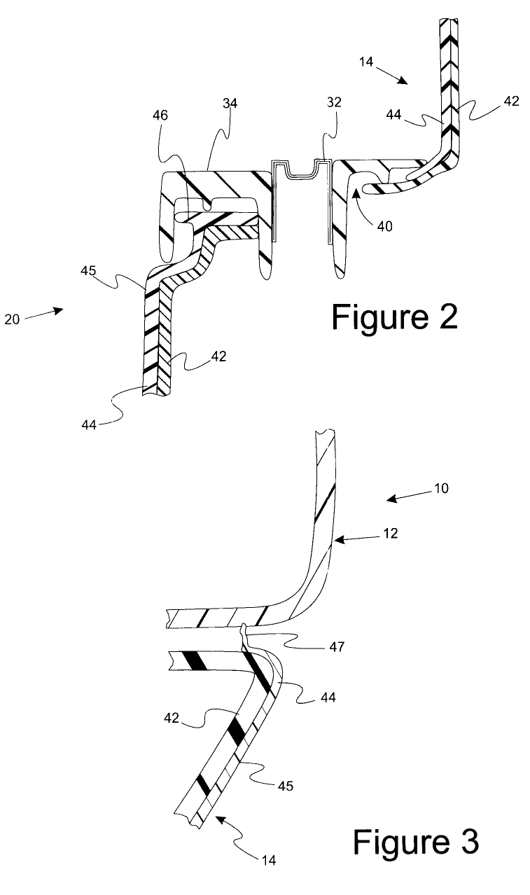

Referring to FIGS. 1 and 2, the armrest 20 includes a plurality of door switches, such as power window control 32. While the power window controls 32 are illustrated as being the switches, other switches or additional switches, such as power locks controls, power mirror controls, and the like, could also be included in the armrest 20. The armrest 20 further includes a switch bezel 34 that covers switches 32. In at least certain embodiments, the switch bezel or cover 34 is made of a relatively hard plastic material and can snap fit within an opening 40 within the armrest 20.

In at least certain embodiments, the bolster 14 includes a substrate 42 made of a relatively hard plastic material and a cover skin 44 made of a relatively softer material that covers a substantial portion of the substrate 42. The substrate 42 can be made of any suitable material known to those of ordinary skill in the art. Suitable examples of materials for making the substrate 42 include, but are not necessarily limited to, PP, PE, TPE, TPU, TPO, and combinations thereof. The substrate 42 can take any suitable shape or configuration. In at least one embodiment, the substrate 42 has an average thickness of 1-5 mm, and in other embodiments of 2.5-3.5 mm.

In at least one embodiment, the cover skin 44 can be made of any suitable material known to those of ordinary skill in the art. In at least one embodiment, the cover skin 44 has a shore A hardness of 50-95, in another embodiment of 60-90, and in yet another embodiment of 70-85.

Furthermore, the cover skin 44 may have any suitable thickness and density. For example, the cover skin may have an average thickness in the range of 0.4 to 1.5 mm and a density in the range of 0.65 to 2.0 g/cm³. In at least one embodiment, the cover skin 44 has an average thickness in the range of 0.75 to 1.25 mm and a density in the range of 0.75 to 1.20 g/cm³. It should be understood, however, that the cover skin 44 may have varying thicknesses throughout its layer.

In at least one embodiment, the cover skin 44 can be made of a relatively soft resin. Typically, useful resins for the cover skin 44 are thermoplastic resins. Particularly useful resins for the cover skin 44 include, for example, thermoplastic polyurethanes, thermoplastic olefins, polyvinyl chloride, polypropylene, and combinations thereof. More specific examples of useful resins for the cover skin 44 include homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the cover skin resin may comprise one or more elastomers. Examples of useful elastomers for the resin include thermoplastic elastomers, thermoplastic urethane, styrene-ethylene-butylene-styrene elastomers, blocked copolymer thermoplastic elastomers, polyolefin-based elastomers, foamed thermoplastic elastomers, and combinations thereof.

In accordance with an embodiment of the present invention, the cover skin 44 has a finger or sealing portion 46 that extends away from the outer surface 45 of the cover skin 44. The sealing portion 46 engagingly cooperates with the switch bezel 34 when the switch bezel is engaged within the opening 40 to provide a seal. This seal prevents dust and other debris from extending between switch bezel 34 to the underside of the switches 32.

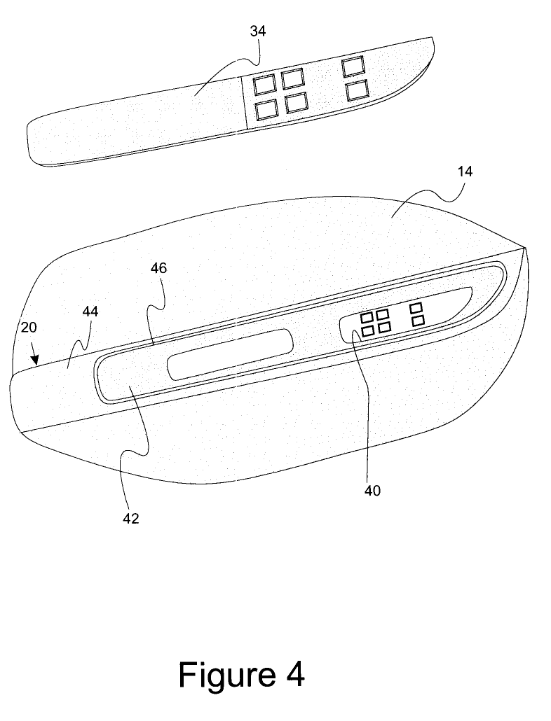

FIG. 4 illustrates certain components of the bolster 14 in exploded view. As can be seen in FIG. 4, the switch bezel 34 is disposed from the armrest 20. In this illustrated embodiment, the sealing portion or seal 46 extends upwardly (i.e. parallel with openings) from the upper surface 45 of the cover skin 44 and the substrate 42 has a portion exposed adjacent the seal 46 about opening 40.

In at least one embodiment, the sealing portion 46 extends about the opening 40. In certain embodiments, the sealing portion 46 extends entirely about the opening 40 to form a generally rectangular-shaped finger or sealing portion that cooperates with the switch bezel 34 to form a seal. In other embodiments, the sealing portion 46 extends about the opening only in a discontinuous manner such that the sealing portion has at least one pair of opposed ends that do not contact each other. The sealing portion 46 can extend away from the opening 40 as shown in FIG. 2, i.e. perpendicularly, or could extend adjacent the opening as shown in FIG. 4, i.e. parallel to the opening. The finger or sealing portion 46 has an average height, or distance from the upper surface 45 of the cover skin 44 of 0.1 to 8 mm and in other embodiments of 0.5 to 5 mm. In certain embodiments, the sealing portion 46 has a thickness of 0.25 to 2 mm, and in other embodiments of 0.5 to 1 mm. In at least one embodiment, the sealing portion 46 is spaced 0.5 to 2.5 cm from the opening 40.

The sealing portion 46 and the opening 40 can take a variety of shapes and should not be limited by the embodiments disclosed and described herewith so long as the sealing portion cooperates with the bezel switch 34 to provide a seal. Moreover, it is anticipated that a variety of shapes, sizes, and configurations could be embodied in accordance with the present invention. For instance, as shown in FIG. 3, a finger portion or seal taking a squiggle or compressible shape is illustrated as 47. By a squiggled or compressible shape, it is meant that the sealing portion 47 changes direction as it extends away from the upper surface 45 of the cover skin 44 in a collapsible manner. As shown in FIG. 3, the compressible portion 47 can provide a seal at various locations of a trim panel. As shown in FIG. 3, the compressible portion 47 is providing a seal between the bolster 14 and the major panel portion 12.

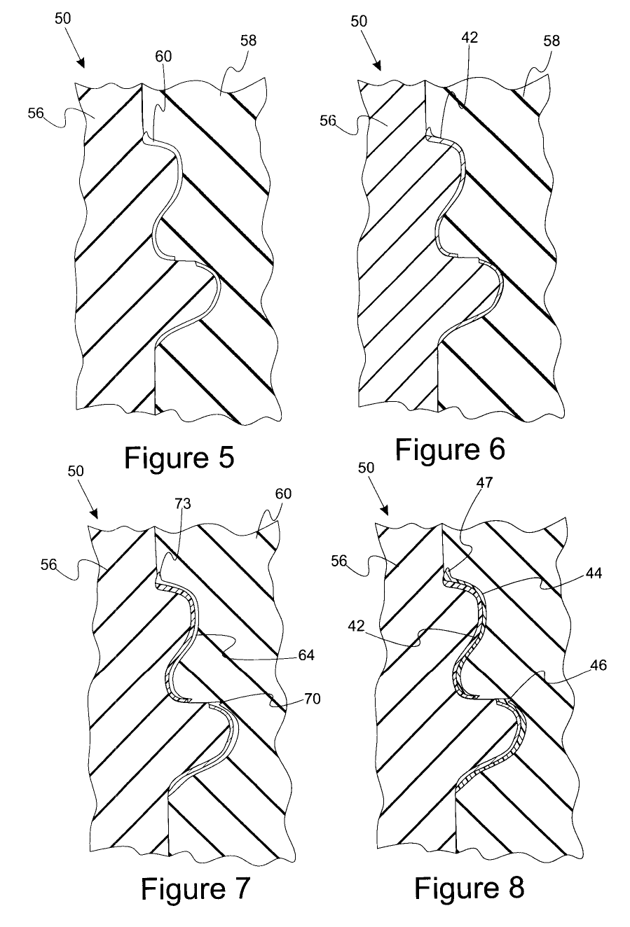

Referring to FIGS. 5-6, a method of making a bolster 14 in accordance with an embodiment of the present invention will be described. FIG. 5 illustrates a mold tool 50 having a core half 56 and a first cavity half 58. As shown in FIG. 5, when the mold tool 50 is closed (i.e., the core half 56 and the first cavity half 58 are brought together), a cavity 60 is formed within the mold tool. A channel (not shown) is in communication with the cavity 60. A first resin is introduced into the mold cavity 60 via channel (not shown). Typically, the first resin is injected into the mold cavity 60 at a temperature from 350° F. to 450° F. and at a pressure from 200 psi to 2100 psi. It should be appreciated that these temperatures and pressure ranges can vary depending upon the materials used. The first resin flows through the mold cavity 60 filling the mold cavity as can be understood from FIG. 6. The first resin upon cooling or curing forms substrate 42.

In at least one embodiment, the first cavity half 58 is capable of rotational movement relative to the core half 56. This allows the first cavity half 58 to rotate away from the core half 56 and a second cavity half 60 to rotate towards and be brought together with the core half 56 to form a second cavity 64. In this embodiment, the core half 56 is stationary. The second cavity half 60 includes a channel (not shown) for communicating with the second cavity 64. The second cavity 64 has the general shape of the bolster 14 and includes a first projection 70 and a second projection 73 extending away from the outer surface area of the bolster. The projections 70 and 73 are the shape of sealing portion 46 and compressible finger portion 47, respectively. While two projections 70 and 73 are shown, it should be understood that only one of seals 46 or 47 may be needed and as such one cavity 70 or 73 could be omitted and their location could vary as desired.

When the core 56 and the second cavity half 64 are closed, a second resin is injected into the second cavity 64 at a temperature from 350° F. to 600° F. and at a pressure from 200 psi to 2100 psi. It should be appreciated that these temperatures and pressure ranges can vary depending upon the materials used. The second resin flows to the second cavity 66 and upon cooling or curing forms cover skin 44 and projection tab 46. During rotation of subsequent molding, the substrate 42 is typically held in the place on core 56 by any suitable means, such as by clips, hooks, or vacuum techniques which are known to those of ordinary skill in the art, or by other suitable means known to those of ordinary skill in the art.

In at least one embodiment, the major panel portion 12, substrate 42, and bezel switch 34 can independently or collectively be made of any suitable resin such as a relatively hard, relatively rigid resin. Typically, useful resins for these components (panel portion 12, substrate 42, and switch bezel 34), or the first resin, are thermoplastic resins. Particularly useful resins for the components include, for example, thermoplastic polyurethanes, thermoplastic olefins, polyvinyl chloride, polypropylene, and combinations thereof. More specific examples of useful resins for the major panel portion 12 include homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the major panel portion 12 (and also substrate 42) and the skin 44 of the bolster 14 are made of different materials to provide a different appearance and/or feel between the major panel portion 12 and the bolster 14. The skin 44 of the bolster 14 can be made of any suitable resin. Typically useful resins for the skin 44 of the bolster 14 or the second resin are thermoplastic resins. Useful second resins include, for example, thermoplastic polyurethanes, thermoplastic olefins, polyvinyl chloride, polypropylene, and combinations thereof. More specific examples of useful resins for the skin 44 of the bolster 14 include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Since the bolster 14 is usually softer than the door panel portions 12 the resin 86 for the bolster 14 may also comprise one or more elastomers. Examples of useful elastomers for the bolster 14 include thermoplastic elastomers, styrene-ethylene-butylene-styrene elastomers, blocked copolymer thermoplastic elastomers, polyolefin-based elastomers, foamed thermoplastic elastomers, and combinations thereof. Also, the second resin 86 could result in a different color than the first resin 74. In at least one embodiment, the first resin 74 comprises TPO and the second resin 86 comprises TPE.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for making an automobile interior trim panel, said method comprising:
a) providing a mold tool system comprising a first mold half, a second mold half and a third mold half;
b) positioning the first mold half and the second mold half proximate each other to form a first mold cavity;
c) introducing a first resin into the first mold cavity, the resin, upon cooling, forming a trim panel substrate;
d) positioning the first mold half with the trim panel substrate and the third mold half proximate each other to form a second mold cavity, the second mold cavity generally contouring to the shape of the trim panel, the second mold cavity having a first minor cavity extending generally transverse to the exterior surface of the second mold cavity; and
e) introducing a second resin into the second mold cavity, the second resin, upon cooling, forming a cover skin extending over the substrate, the cover skin having an outer surface and a tab portion extending generally away from the outer surface.

2. The method of claim 1 wherein an opening is formed within the trim panel substrate.

3. The method of claim 2 wherein the tab portion extends generally parallel to the opening.

4. The method of claim 2 wherein the tab portion extends generally perpendicular to the opening.

5. The method of claim 1 wherein the step of positioning the first mold half with the trim panel substrate and the third mold half proximate each other comprises rotating the second mold half away from the first mold half and rotating the third mold half towards the first mold half.

6. The method of claim 1 wherein the second resin comprises a relatively durable material resulting in the cover skin having a shore A hardness of 50-95.

7. The method of claim 6 wherein the second resin comprises a thermoplastic resin and the cover skin has an average thickness of 0.5-1.5 mm.

8. The method of claim 7 wherein the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

9. The method of claim 8 wherein the second resin comprises thermoplastic elastomer.

10. The method of claim 7 wherein the first resin is injected into the first mold cavity at a temperature from 350° to 440° F. and a pressure from 200 psi to 2100 psi.

11. The method of claim 13 wherein a first resin selected from the group consisting of PP, PE, TPE, TPU, TPO, and combinations thereof.

12. The method of claim 1 wherein the second cavity has a second minor cavity extending generally transverse to the exterior surface of the second mold cavity.

13. The method of claim 1 wherein the substrate and the cover skin form a bolster, the method further comprising providing a major door panel portion, and supporting the bolster on the major door panel portion to form a door panel.

14. A method for making an automobile interior trim panel, said method comprising:
a) providing a mold tool system comprising a first mold half, a second mold half and a third mold half,
b) positioning the first mold half and the second mold half proximate each other to form a first mold cavity;
c) introducing a first resin into the first mold cavity, the resin, upon cooling, forming a trim panel substrate having an opening therein;
d) positioning the first mold half with the trim panel substrate and the third mold half proximate each other to form a second mold cavity, the second mold half having a cavity surface generally contoured to the shape of the trim panel, the second mold cavity having a first minor cavity extending generally transverse to the cavity surface of the second mold cavity;
and
e) introducing a second resin into the second mold cavity, the second resin, upon cooling, forming a cover skin extending over at least a substantial portion of the substrate, the cover skin having an outer surface and a tab portion extending generally away from the outer surface, the tab portion circumscribing the opening and being spaced 0.25 to 5 cm from the opening.

15. The method of claim 14 wherein an opening is formed within the trim panel substrate.

16. The method of claim 15 wherein the tab portion extends generally parallel to the opening.

17. The method of claim 15 wherein the tab portion extends generally perpendicular to the opening.

18. The method of claim 14 wherein the second cavity has a second minor cavity extending generally transverse to the exterior surface of the second mold cavity.

19. An automobile interior trim panel comprising a trim panel substrate having an opening therein, and a cover skin extending over at least a portion of the substrate, the cover skin having an outer surface and a tab portion extending generally away from the outer surface, a plurality of switches disposed within the openings and a switch bezel disposed between the switches and the substrate, the switch bezel cooperating with the tab portion to provide a seal.

20. The trim panel of claim 19 wherein the tab portion has a height of 0.25 to 5 mm and a thickness of 0.25 to 5 mm.
